(19) United States
(12) Patent Application Publication
(10) Pub. No.: US 2015/0267136 A1
(43) Pub. Date: Sep. 24, 2015

(54) GAS PROCESSING SYSTEM AND METHOD FOR BLENDING WET WELL HEAD NATURAL GAS WITH COMPRESSED NATURAL GAS

(71) Applicant: Pride of the Hills Manufacturing, Inc., Big Prairie, OH (US)

(72) Inventors: Curtis W. Murray, SR., Big Prairie, OH (US); Curtis W. Murray, JR., Wooster, OH (US); Leroy P. Whited, Elyria, OH (US); Dustin Baker, Shreve, OH (US)

(73) Assignee: Pride of the Hills Manufacturing, Inc.

(21) Appl. No.: 14/662,929

(22) Filed: Mar. 19, 2015

Related U.S. Application Data
(60) Provisional application No. 61/968,027, filed on Mar. 20, 2014.

(51) Int. Cl. C10L 3/10; F02D 19/06; C10L 3/06; B01F 15/06

(52) U.S. Cl. CPC C10L 3/10; B01F 15/06; F02D 19/0647; C10L 3/06; C10L 2270/02; C10L 2290/24; C10L 2290/06

(57) ABSTRACT

A gas processing system and method for blending wet well head natural gas with compressed natural gas is provided. The system has two inlets in communication with a blending chamber. The blending chamber is preferably defined by a heat exchanger. One inlet receives an amount of raw wet well head natural gas therethrough. The second inlet receives an amount of processed and compressed natural gas therethrough. The two gases are mixed and sent to a downstream destination.

### CROSS REFERENCE TO RELATED APPLICATION

This application claims priority from U.S. Provisional Application Ser. No. 61/968,027, filed Mar. 20, 2014; the disclosure of which is incorporated herein by reference.

### BACKGROUND OF THE INVENTION

1. Technical Field

The present invention relates generally to the extraction of fossil fuels at a well site. More particularly, the present invention relates to a gas processing system. Specifically, the present invention relates to a system and method of operating a well site.

2. Background Information

It is hardly questionable that fossil fuels and natural resources, such as oil and natural gas, are finite. As such, in recent years global in-ground gas exploration has been an ever expanding industry in order to claim the limited amount of remaining fossil fuels contained in the earth. Both natural gas and oil exploration and extraction require that wells are drilled to access the deep pockets of potential energy stored within the earth's crust. The pockets of fossil fuels stored within the earth have no relation or bearing for human development and civilization existing atop the earth's surface. This is why some oil and gas wells are located in the farthest reaches of the Artic, the extreme dessert sands of the Middle East, and the deep waters of the oceans. Many other gas well sites are not as remote, but still not close to commercialized civilization, such as in the hilly region of Southern and Eastern Ohio, United States of America.

One exemplary source of fossil fuels it the Utica Shale. The Utica Shale is composed of calcareous organic rich shale. Amongst other places, the Utica Shale is a deep source of oil and natural gas position deep below the southern portion of Ohio. Although the prospective Utica area extends into Pennsylvania and West Virginia, as of 2013, most well drilling activity has been in Southern and Eastern Ohio, because the Ohio portion is believed to be richer in oil, condensate, and natural gas liquids.

Extracted well gas cannot be used directly in a combustion engine. Well gas or fossil fuels directly leaving the ground contains various liquids and particulate matter. For each gas and oil, the fossil fuel must be processed (essentially cleaned and depressurized) prior to use in a combustion engine. Wellhead gas requires purification to make it “pipeline quality” of “engine combustible gas” for market. These quality criterions are generally in the range of: 1,010 BTU+5%; <7 lbs. water vapor (H2O) per 1000 Mcf; <1% Oxygen (O2); <4% Carbon Dioxide (CO2); <3% Nitrogen (N2); <20 grains total Sulfur (S) (mg/m3); <1 grain Hydrogen Sulfide (H2S).

A gas well drilling and extraction operation is a highly technical accomplishment that requires many laborers and extremely sophisticated machines. Often, the machines used during a drill operation are combustion engines driving pumps, electricity generators, and drills, amongst others. Further, the remote locations of well sites create numerous logistical challenges for the individuals charged with extracting these natural resources. Simply getting processed fuel to these remote locations to operate the heavy machinery can be a challenge.

Often a vast infrastructure of supply pipes and electrical lines must be constructed before a well can even begin producing oil or natural gas. The infrastructure is utilized to bring fuels and power to the well site, as well as carry away extracted well gas to an off-site processing facility. The time to lay the infrastructure alone can take years. This delay causes a backlog of potential earnings and profits for the fossil fuel claim holders.

Thus, a need exists for a way of operating a processing facility adjacent a gas well site. The present invention addresses this need and other issues.

### SUMMARY

In one aspect, an embodiment may provide a method of operating a well using gas processed at a same well site is provided. The method discloses of providing a well site defined by a perimeter. In ground fossil fuel is extracted and distributed to a processing facility. The processing facility is wholly located within the perimeter of the well site. Once the fossil-fuel is processed into an engine quality combustible gas, it is moved to a downstream destination. Preferably, the downstream destination is located within the perimeter. An exemplary downstream destination is a combustion engine, wherein the processed gas is burned to create an amount of work. The work drives a device also located within the perimeter. An exemplary device is a pump used to draw fossil fuel from within the earth. Thus, this method provides a way to draw fossil fuel upwards, process it, and burn it, all within the perimeter of the well site.

In one aspect, an embodiment of an invention may provide a method of operating a well using gas processed at a same well site, comprising the steps of: providing a well site having a ground surface and defined by a perimeter; providing a well structure installed on the well site, the well structure including a frame, a pipe casing connected to the frame, a portion of the pipe casing extending downwardly below the surface of the well site in communication with an in-ground fossil fuel source, and a well head located adjacent where the casing pipe meets the ground surface; extracting the fossil fuel from the ground upwardly through the pipe casing; and processing the fossil-fuel to create a combustible engine gas, wherein at least a portion of the fossil-fuel is processed within the perimeter.

Another aspect of an embodiment of an invention may provide a method of operating a well using gas processed at a same well site, comprising the steps of: providing an amount of fossil fuel contained within the ground, said fossil fuel in fluid communication with a pipeline casing, the pipeline casing extending from the fossil fuel towards a well head at the ground surface; moving the fossil fuel at least partially upwards from within the earth through the pipe casing towards the well head; moving the fossil fuel from the well head to a processing system, wherein the processing system is located wholly within a well site, the well site defined by a perimeter; moving the fossil fuel through the processing system to create an engine combustible gas, said processing system comprising at least one of a coalescer, a desiccant dryer, a particulate filter, and a heat exchanger; and moving the engine combustible gas to a downstream destination.

In yet another aspect, an embodiment of an invention may provide a method of operating a well site, the method comprising the steps of: providing a combustion engine, said engine configured to combust at least one of an amount of gasoline, an amount of diesel, an amount of natural gas, an amount of methane, and an amount of propane; disposing the engine within a well site area, wherein the well site area is defined by a perimeter; processing an amount of fossil fuel within the well site area to create the at least one amount of gasoline, an amount of diesel, an amount of natural gas, an amount of methane, and an amount of propane to create a processed gas; fueling the combustion engine with the processed gas; and combusting the processed gas within the engine to create a work output.

In yet another embodiment, one aspect of the invention may provide a method for operating a gas processing facility comprising the steps of: moving a fossil fuel along a pathway through a mobile gas processing facility positioned adjacent a well site; sensing a first fuel event along the pathway; generating a first signal including digital data of the first fuel event; sending the first signal wirelessly from a computer system to a first remote access device and then receiving the first signal in the first remote access device; interpreting the first signal; and actuating a first element of the gas processing facility in response to the first signal.

In another embodiment, one aspect of the invention may provide a method comprising the steps of: moving wet well head natural gas downstream along a gas flow pathway through a mobile gas processing system, the mobile gas processing system positioned on a well site location; moving processed and compressed natural gas (CNG) downstream through a portion of the gas processing system along the pathway; blending the wet gas with the CNG along the pathway of the processing system creating a blended gas; and feeding the blended gas to a downstream destination.

Additionally, yet another aspect may provide a mobile gas processing system positioned on a well site location, the gas processing system comprising: a heat exchanger including at least two inlets and adapted to receive CNG through a first inlet and wet gas through a second inlet; and a blending pathway defined by the heat exchanger; wherein the two inlets are in fluid communication with the blending pathway.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an environmental side view of the present invention depicting a mobile processing facility located adjacent a well site;

FIG. 1A is a schematic top view of the environment depicting the processing of fossil fuel or well head gas occurring within the perimeter of a gas well site area;

FIG. 1B is a schematic top view of an alternative embodiment depicting the blending of well head gas with compressed natural gas, the compressed natural gas source positioned either on site or off site;

FIG. 2 is a schematic representation depicting that the right side of FIG. 2A aligns with the left side of FIG. 2B;

FIG. 2A is an enlarged side view of the front half of the mobile processing facility, wherein the right side is cut-off with a dash-dot line indicating a continuance with FIG. 2B;

FIG. 2B is an enlarged side view of the rear half of the mobile processing facility, wherein the left side is cut-off with a dash-dot line indicating the continuance from FIG. 2A;

FIG. 3 is a schematic representation depicting that the right side of FIG. 3A aligns with the left side of FIG. 3B;

FIG. 3A is an enlarged top view of the front half of the mobile processing facility, wherein the right side is cut-off with a dash-dot line indicating a continuance with FIG. 3B;

FIG. 3B is an enlarged top view of the rear half of the mobile processing facility, wherein the left side is cut-off with a dash-dot line indicating the continuance from FIG. 3A;

FIG. 4 is a cross section taken along line 4-4 in FIG. 3A depicting an enlarged side view of a first filter and a first dryer mounted atop a platform of the mobile processing facility;

FIG. 5 is a cross section taken along line 5-5 in FIG. 3A depicting an enlarged side view of the first filter and a second filter;

FIG. 6 is a cross section taken along line 6-6 in FIG. 3A depicting an enlarged side view of the first dryer and a second dryer;

FIG. 7 is a flow chart of an exemplary method of operating an embodiment of the present invention;

FIG. 8 is a flow chart of an exemplary method of operating an alternative embodiment of the present invention;

FIG. 9 is a flow chart of an exemplary method of operating an alternative embodiment of the present invention;

FIG. 10 is a flow chart of an exemplary method of operating an alternative embodiment of the present invention;

FIG. 11 is a flow chart of an exemplary method of operating an alternative embodiment of the present invention; and

FIG. 12 is a flow chart of an exemplary method of operating an alternative embodiment of the present invention.

Similar numbers refer to similar parts throughout the drawings.

### DETAILED DESCRIPTION

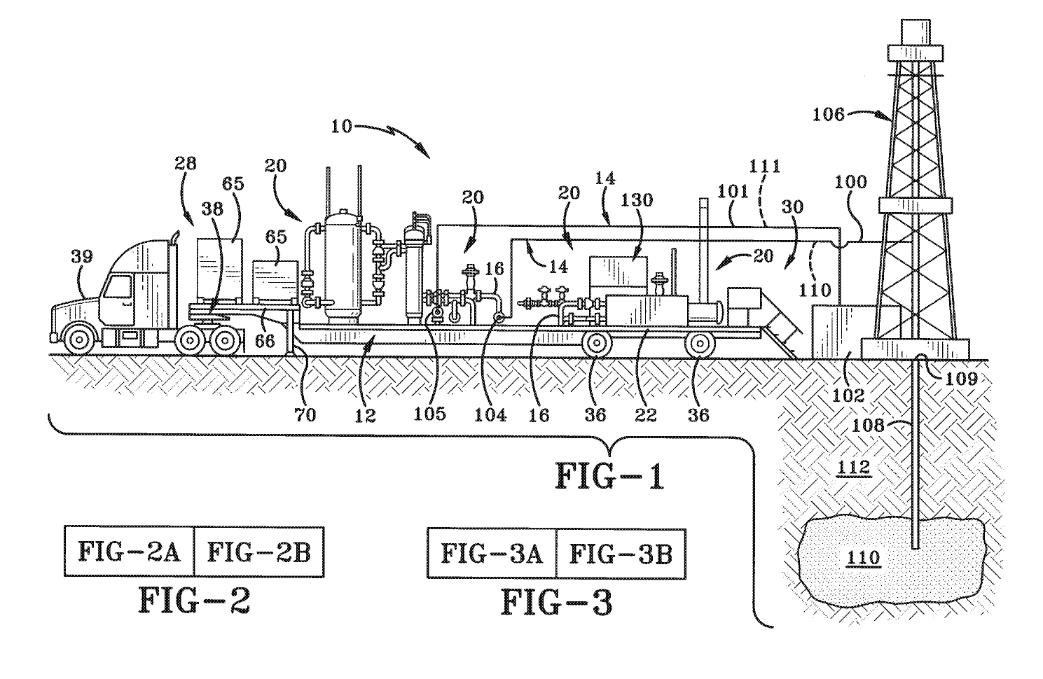

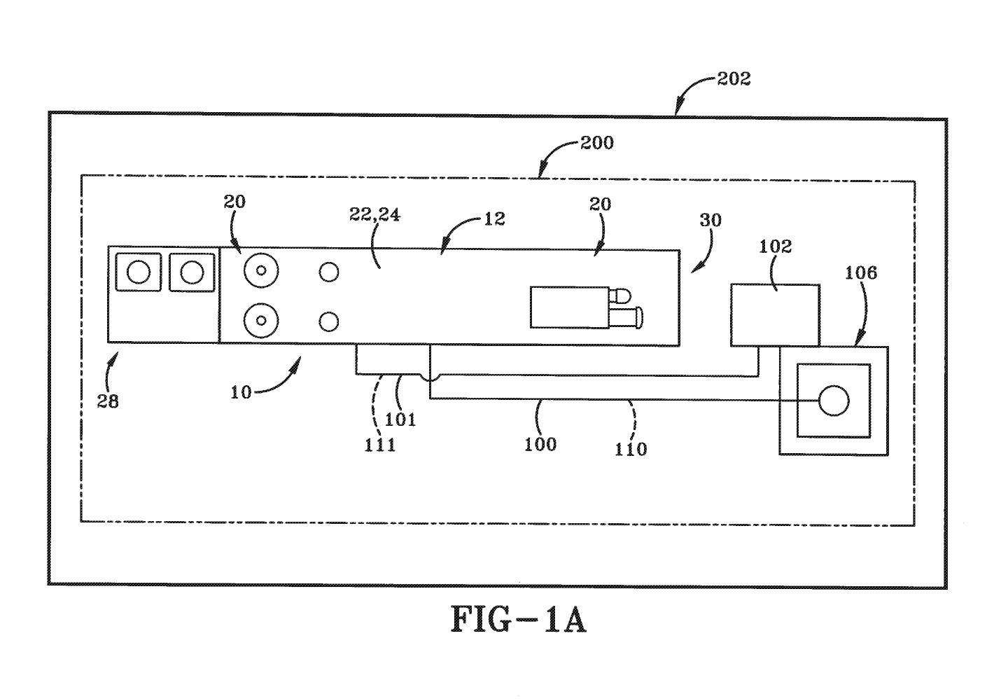

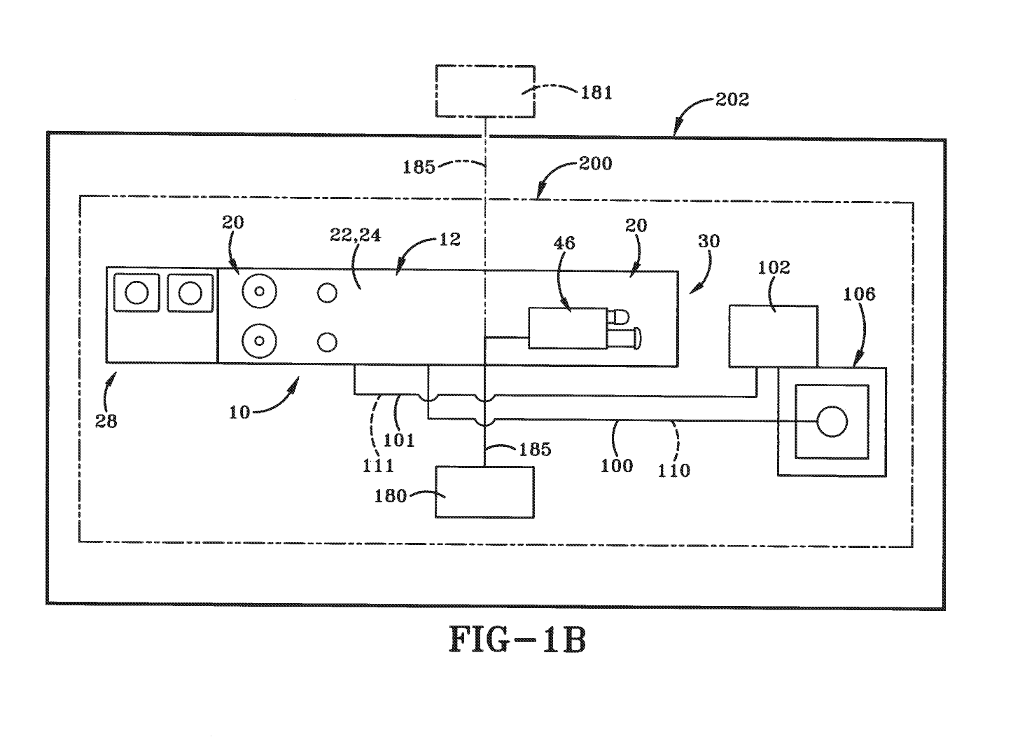

With reference to FIG. 1, the well gas mobile processing facility 10 of the present invention includes a trailer 12, a gas flow stream pathway 14, a series of pipelines 16, and a well gas processing system 20. In accordance with an embodiment of the present invention, facility 10 allows wellhead gas extracted or drilled from a well at a gas well site to be processed adjacent the well at the well site such that processed gas can then be used to run other equipment or machines located at the well site. Facility 10 is an in situ mobile processing plant at a well site.

As shown in the schematic top view of FIG. 1A, well gas processing facility 10 is wholly located within a perimeter 200 of a gas well site location. Within perimeter 200 of well site lies the processing system 20, a well 106, a pump or engine 102. As is ordinarily the case, the perimeter 200 of well site is located wholly within one real property parcel boundary 202. Preferably, parcel 202 is owned at least partially by one of: a person, a group of persons, a trust, and a business entity.

As shown in FIG. 1B, a compressed natural gas (CNG) source 180 can be positioned within perimeter 200 of well site. CNG source 180 is connected via a source line 185 and is in communication with processing system 20. CNG source 180 is connected to a heat exchanger 46. Alternatively, an embodiment of the present invention provides a CNG source 181 positioned outside of perimeter 200 (i.e. offsite). The CNG fed from either of sources 180, 181 are cleaned and already processed. The CNG contained in each respective source is preferably processed from a different facility, not facility 10; however, clearly it is possible for facility 10 to process and store the CNG in sources 180, 181.

Referring back to FIG. 1, flow stream pathway 14 extends from an upstream gas source, shown as in-ground gas or fossil fuel 110 towards a downstream gas destination. The downstream gas destination is preferably a combustion engine machine or device located at a well site, for example a pump 102. Pump 102 is located at or adjacent the well site and used to extract wet well head gas 110 from the earth surface 112. Alternatively, the downstream gas destination can be one or more storage or holding tanks 65 configured to store processed, clean, and useable gas 111 or a combustion engine generator.

Trailer 12 includes a platform 22 to which most components or elements of the processing system 20 are mounted or attached. Platform 22 includes an upwardly facing top surface 24 and a downwardly facing bottom surface 26 that therebetween define a vertical direction. Platform 22 has a forward end 28 and a rear end 30 that therebetween define a longitudinal direction. Platform 22 has a left side 32 and a right side 34 that therebetween define a lateral direction. A plurality of ground engaging wheels 36 are mounted beneath bottom surface 26 to a conventional axle suspension system for a trailer as one having ordinary skill in the art would understand. A trailer hitch 38 is located near forward end 28 and configured to attach trailer 12 to a truck or vehicle 39 to allow facility 10 to be towed into and away from the well site. Trailer 12 may further include additional elements ordinarily associated with trailers for towing behind vehicles such as landing gear 70, fairings, winches or other tie down members.

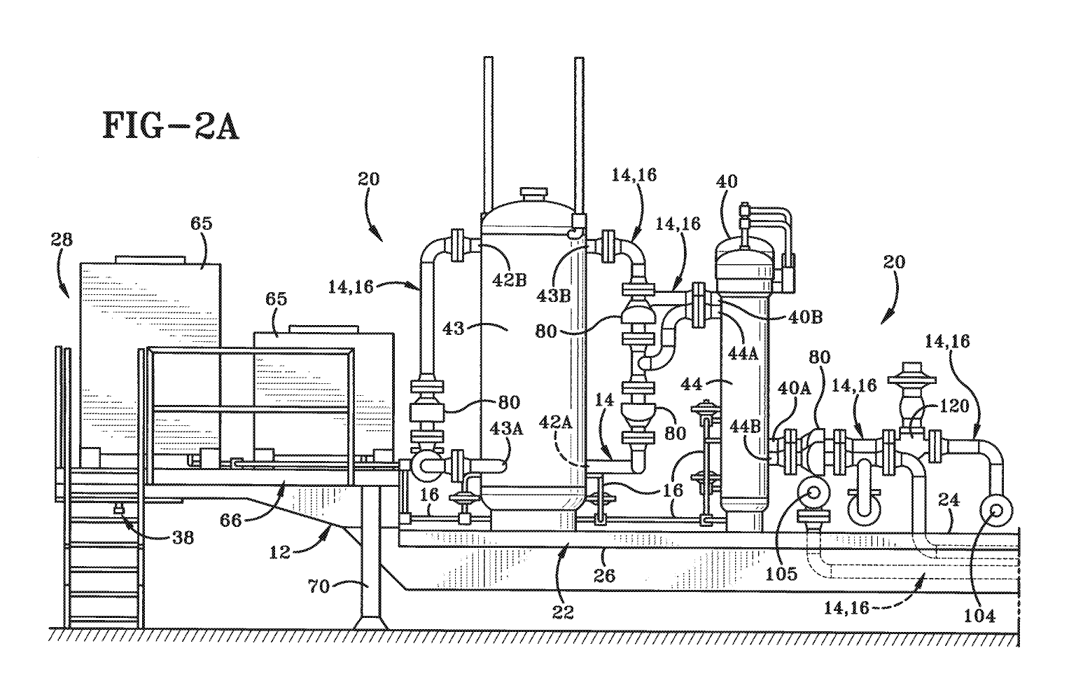

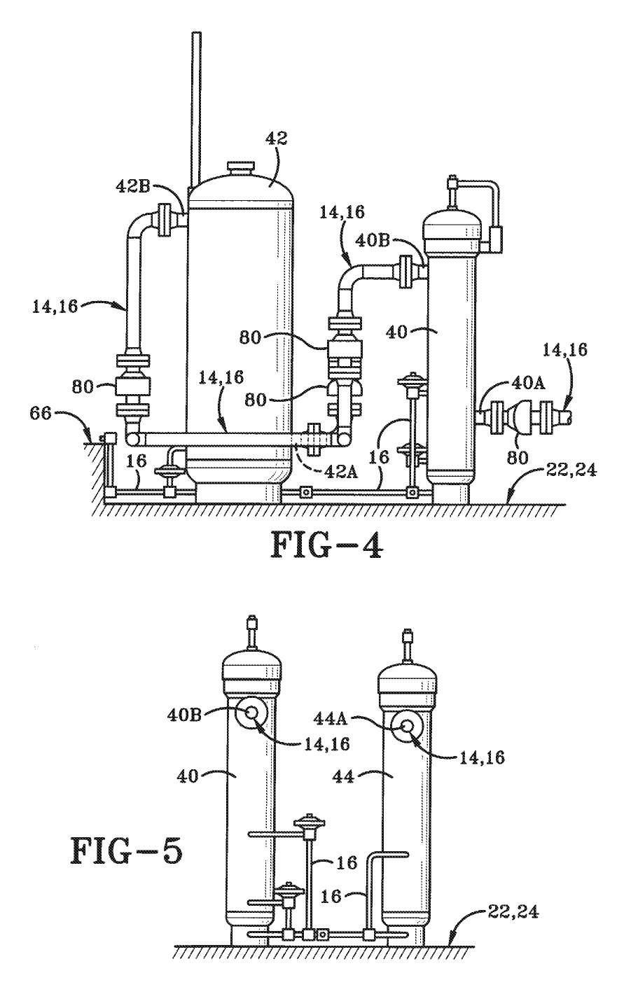

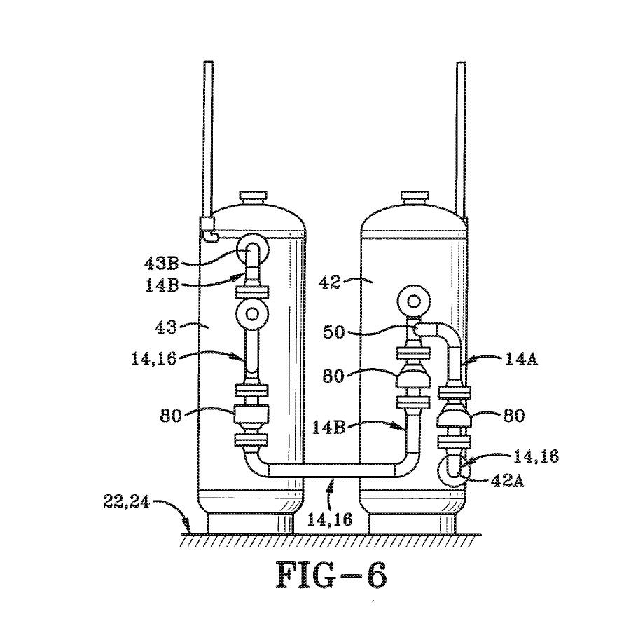

With primary reference to FIGS. 2-6, the well gas processing system 20 is connected to trailer 12 and is at least partially mounted above top surface 24 of platform 22. Wellhead gas processing system 20 comprises a coalescing filter 40, at least one desiccant dryer 42, a particulate filter 44, a heat exchanger 46, and a meter run 48.

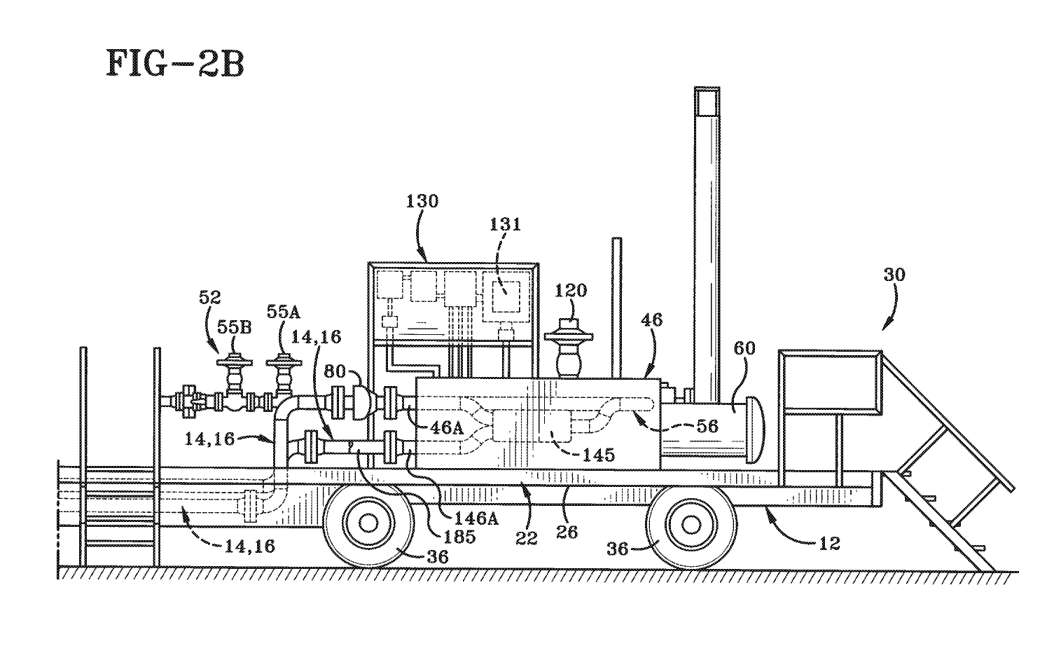

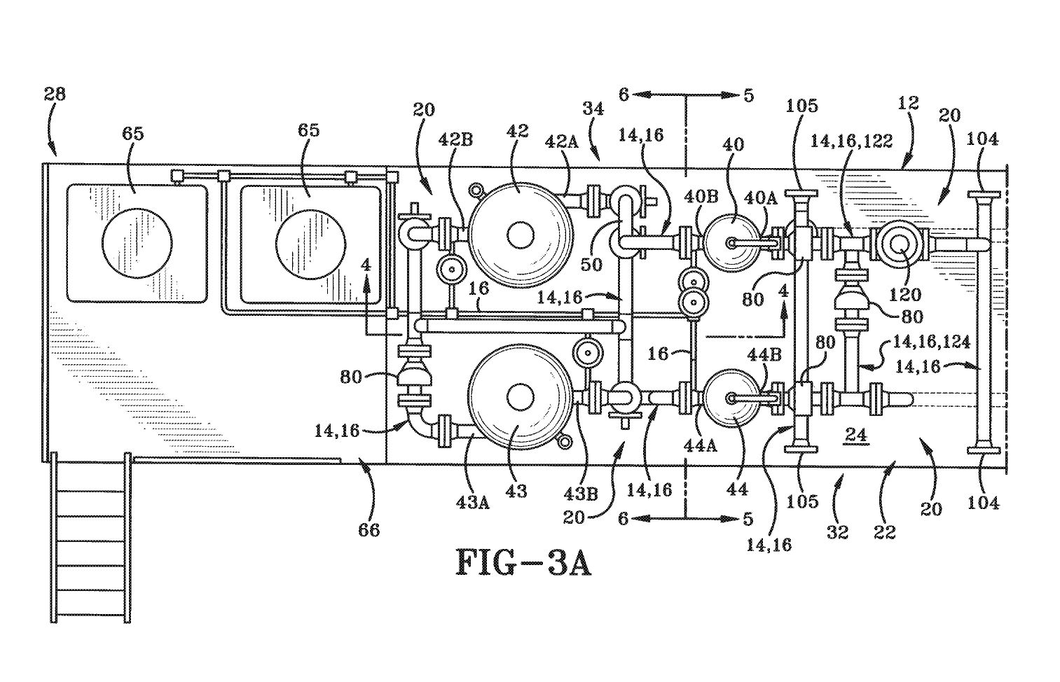

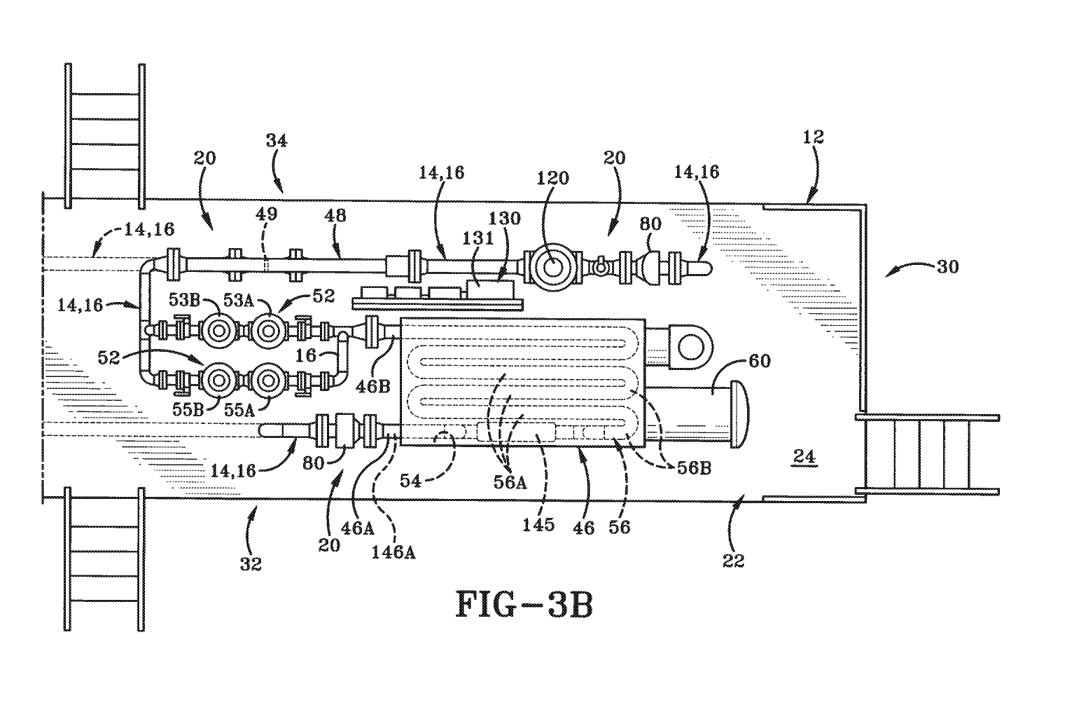

Coalescing filter or coalescer 40 defines a portion of and is positioned along gas flow stream pathway 14. Preferably, coalescer 40 is mounted atop platform 22 and positioned forwardly of inlet valve 104 when viewed from the side (FIG. 2A). Coalescer 40 is positioned to the right of filter 44 when viewed from above (FIG. 3A), and rearwardly of the at least one dryer 42. Coalescer 40 is in fluid communication with inlet 104 and manifold 50 via connected pipes 16.

Coalescing filter 40 is preferably cylindrically shaped having a top end and a bottom end with a vertically extending cylindrical side wall extending therebetween. Coalescing filter 40 defines an interior chamber, through which forms a portion of pathway 14. Coalescing filter 40 includes an inlet 40A and an outlet 40B, each formed in the vertical side wall of coalescing filter 40. Coalescing filter 40 is connected via pipeline 16 extending from system inlet 104 to filter inlet 40A. Pipeline 16 is connected to coalescing filter outlet 40B and extends defining a portion of the gas flow stream pathway 14 and extends to a manifold 50.

Manifold 50 bifurcates gas flow stream pathway 14 into two segments 14A, 14B respectively defined by pipe 16. Manifold 50 is connected to trailer 22 and is positioned above the top surface 24 when viewed from the side (FIG. 2A). Manifold 50 is positioned rearwardly from dryer 42 and forward from coalescer 40. Manifold 50 is at a vertical height lower than the top of coalescer 40.

Each segment 14A, 14B extends vertically below manifold 50 for a distance. Similar to manifold 50, each segment 14A, 14B is connected to trailer 22 and is positioned above the top surface 24 when viewed from the side (FIG. 2A). Further, segments 14A, 14B are each positioned rearwardly from dryer 42 and forward from coalescer 40. Segments 14A, 14B may each be selectively closed via valves 80 such that gas flowing through system 20 purposefully bypasses either of dryer 42, 43 when necessary. This selected guidance of gas flow allows system 20 to remain operation while an action is performed on a dryer. For example, dryer 42 may need repair work, thus, segment 14A would be closed off and all gas flow would be directed towards dryer 43 along segment 14B. Additionally, alternative embodiments of the present invention permit for both segments 14A, 14B to be closed and both dryers 42, 43 are bypassed permitting gas flow directly to filter 44 or heat exchanger 46.

At least one desiccant dryer 42 is positioned forwardly from manifold 50. A second desiccant dryer 43 is also positioned forward from manifold 50. Each dryer 42, 43 is positioned rearwardly from at least one storage tank 65. Dryers 42, 43 are preferably side-by-side at a same longitudinal position atop platform 22. First desiccant dryer 42 connects to first segment 14A and a second desiccant dryer 43 connects to second segment 14B.

Each desiccant dryer 42, 43 contains a top and a bottom with a vertically extending cylindrical side wall extending therebetween. The respective bottoms of dryers 42, 43 are mounted to platform 22. Desiccant dryer inlets 42A, 43A and desiccant dryer outlets 428, 43B are formed in the vertical side wall of each desiccant dryer 42, 43 respectively. Each dryer 42, 43 define an interior chamber for storing desiccant pellets. Chambers within 42, 43 each respectively define a portion of the gas flow pathway 14. Desiccant pellets are used to dry gas flowing along pathway 14 through the respective dryer 42, 43. Pipes 16 extend outwardly and form a portion of the downstream pathway 14 from each respective desiccant dryer outlet 42B, 43B. Pipes 16 merge at a union downstream from each desiccant dryer 42, 43 and extend towards particulate filter 44.

Particulate filter 44 is mounted to and positioned above top surface 24 of platform 22. Filter 44 is positioned rearwardly from dryers 42, 43 (when viewed from the side; FIG. 2A) and laterally to the left of coalescer 40 (when viewed from above; FIG. 3A). Particulate filter 44 includes a top end and a bottom end with a vertically extending cylindrical side wall extending therebetween. Particulate filter 44 defines an inner filter chamber through which gas flows through a filter membrane. The inner filter chamber defines a portion of the gas flow pathway 14. An inlet 44A and an outlet 44B are each formed in the cylindrical side wall of particulate filter 44 and are in communication with inner filter chamber. The bottom of particulate filter 44 is connected to platform 22 of trailer 12. Pipe 16 extends downstream connecting outlet 44B of particulate filter 44 to an inlet 46A of heat exchanger 46.

Heat exchanger 46 is mounted to above top surface 24 of platform 22. Further, heat exchanger 46 is positioned rearwardly from coalescer 40 and filter 44. Heat exchanger 46 defines a portion of gas flow stream pathway 14. Heat exchanger 46, having an inlet 46A and outlet 46B, includes a box frame defining an interior chamber 54, and a serpentine pipeline 56 winding within the chamber 54 towards a heat exchanger outlet 46B. Interior chamber 54 may be filled with glycol or other similarly situated fluid. In one embodiment, chamber 54 is filled with a fluid mixture of glycol, ethylene, and water. Outer surface of pipeline 56 contacts the fluid mixture in chamber 54. Serpentine pipeline 56 is in fluid communication with inlet 46A and outlet 46B. The heat exchanger serpentine pipeline 56 may include multiple linear pipeline segments 56A connected together by arcuately extending pipeline segments 56B to form the serpentine pipeline 56.

Heat exchanger 46 further includes a heating element 60 or burner management unit configured to heat the serpentine pipeline 56 by heating the fluid mixture in chamber 54, and may include an exhaust stack to release exhaust waste products in the production of heat. In one preferred embodiment, heating element 60 is maintained at a temperature in a range from about 600° F. to about 800° F. More particularly, element 60 is from about 725° F. to about 775° F., and preferably is 750° F. This heats and thus imparts a temperature to the fluid mixture (glycol, ethylene, and water) in chamber 54. The fluid mixture is in a range from about 150° F. to 200° F., more particularly in a range from 170° F. to 180° F., and preferably at 175° F. This heated fluid keeps pipes 56 at a warm temperature while gas is expanded therein to reduce the pressure from a high first pressure to a lower second pressure.

Heat exchanger 46 may further comprise a second inlet 146A connected to source line 185 for receiving already processed CNG from source 180 or 181. Both inlets, 46A and 146A, are in communication with a blending chamber or blending duct 145. Blending chamber 145 may define a blending pathway which is a portion of stream pathway 14. Blending duct 145 is defined by a portion of pipes 56 in chamber 54. Blending chamber 145 is configured to receive a first amount of wet well head raw gas that can be moving from filter 44, or that has bypassed coalescer 40, dryers 42, 43, and filter 44, wholly or partially. Blending chamber further receives a second amount clean CNG from source 180 or 181. The first and second amounts are blended together in chamber 145.

CNG is usually stored at high pressure, for example 3500 psi or higher. This requires more heat to overcome the additional expansion cooling created by the larger pressure drop when blending in chamber 145. The heater 46, namely, element 60 would have to be sized to provide this additional heat. Also, higher pressure rated coils would have to be provided to take this initial pressure drop. A high pressure preheat coil and an expansion coil are provided with a regulator or automated choke placed between the two coils to take the initial pressure drop before going through the final regulator set. This CNG supply system is placed in the same heater, but would operate independently of the wellhead gas processing system. After the pressure is regulated to usable limits, the gas is measured and an automated flow control system controls the mixing. Both the wellhead and CNG gas systems are measured individually and then the proper amount of each mixed to make the blend required.

In the case of deficit make up gas, the CNG is regulated to make up the needed amount. When blending gas to lower the Btu value, based on gas sample analysis, either a set percentage is used or a gas chromatograph is used to control the blend rate to achieve the required Btu value.

A plurality of regulators 52 are connected via pipeline 16 to outlet 46B of heat exchanger 46 and are positioned downstream therefrom. Regulators 52 define a portion of gas pathway 14 and are physical positioned forwardly from heat exchanger 46. Downstream from outlet 46B, pipeline branches into two line segments. Downstream from the branch, a first set of regulators 53 are fluidly in parallel with a second set of regulators 55, each set 53, 55 defining a portion of pathway 14. First set 53 includes an upstream active regulator 53A and a downstream monitoring regulator 53B. Regulators 53A, 53B are fluidly aligned is series. Second set 55 includes an upstream active regulator 55A and a downstream monitoring regulator 55B. Regulators 55A, 55B are fluidly aligned is series. Active regulators 53A, 55A each regulate the amount of gas traveling through pipelines 16 along pathway 14 from heat exchanger 46 to meter run 48. Monitoring regulators 53B, 55B, which are respectively downstream from 53A, 55A, monitor the amount of gas regulated from active regulators 53A, 55A as gas travels through pipelines 16 along pathway 14 from heat exchanger 46 to meter run 48. The pathway segments permitting first set 53 and second set 55 to be aligned fluidly in parallel converge at a merging branch in pipeline 16 upstream from meter run 48.

Meter run 48 is positioned downstream and connected via pipelines 16 to the plurality of regulators 52. Meter run or meter pipe 48 is a length of pipe configured to measure flow of processed gas 111 therethrough. Meter 48 defines a portion of the stream pathway 14. Meter run 48 is positioned laterally to the right of heat exchanger 46 when viewed from above (FIG. 3B). Meter 48 has an upstream end and a downstream end. Upstream end of meter 48 is connected to pipeline 16 downstream from regulator 52. Downstream end of meter 48 is connected to an additional regulator. Upstream end of meter run 48 is positioned longitudinally forward of downstream end of meter run relative to platform 22 (when viewed from the above; FIG. 3B).

An orifice meter 49 is connected to the metering pipe 48 to meter an amount of gas flowing along the stream pathway through the metering pipe. Preferably, orifice meter 49 is a plate with at least on aperture formed therein. The plate is disposed within meter pipe 48 and placed within the flow stream pathway 14. Orifice meter 49 constricts the flow of gas along pathway 14 within pipe 48. Then, the pressure differential across the constriction plate of meter 49 is measured yielding the flow rate along pathway 14. The at least one aperture, or a plurality of apertures, may be concentric, eccentric, and segmental. Additionally, while the orifice plate functions as meter 49, clearly, other metering devices, including but not limited to oval gears, helical gears, nutating disks, turbine meters, Woltmann meters, single jets, paddle wheels, multiple jets, pelton wheels, current meters, venture meters, dall tubes, pitot tubes, cone meters, and the like, are contemplated.

An emergency shut-down valve 120 is connected via pipeline 16 to the downstream end of meter run 48. Valve 120 defines a portion of pathway 14 therethrough. Valve 120 has an upstream end and a downstream end, and is selectively lockable in each of an open and a closed position. When in the open position, valve 120 permits fluid flow therethrough. When in the closed position, valve 120 prevent fluid from flowing through. Emergency shutdown valve 120 is in communication with a computer monitoring system 130. System 130 can operate valve 120 within a set of parameter. For example, if system 130 detects, via meter 49, that processed gas 111 is at too great of a pressure, system 130 may move valve 120 from the open position to the closed position. While emergency shut-down valve 120 is preferably located at this position, valve 120 may be configured to be placed along other portions of pathway 14. Further, multiple emergency shut-down valves 120 may be disposed along pathway 14 to ensure safety of system 10.

Computer or monitoring system 130 is an electrical device comprising computer logic software or other integrated software and is configured to monitor gas processing system 20. System 130 is in communication with a signal generator 131 which sends wireless signals to a remote access device. System 130, through logic, may operate free from human monitoring if desired. The term “logic”, as used herein, and with continued reference to system 130, refers to and includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a device to read a software medium, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

A conventional gas valve 80 may be positioned between the system inlet 104 and upstream from the coalescer 40; the valve 80 may be positioned downstream from the coalescer 40 and upstream from the dryer 42, 43; the valve 80 may be positioned downstream from the dryer 42, 43 and upstream from the filter 44; the valve 80 may be positioned downstream from the filter 44 and upstream from the heat exchanger 46; or the valve 80 may be positioned downstream from the heat exchanger 46 and upstream from the system outlet 105, amongst other places. Valve 80 may also be in communication with computer system 130 and function in the event of an emergency as well or if necessary.

A system outlet 105 is positioned on a side (either left 32 or right 34) of trailer platform 22. Preferably, outlet 105 is positioned beneath bottom 26 of platform 22; however other locations are entirely possible. Outlet 105 is connected via pipeline 16 to and is downstream from shut-down valve 120. Outlet 105 defines a portion of pathway 14. Outlet 105 is configured to connect system 20 via line 101 to the downstream gas destination. As shown in FIG. 1, the downstream gas destination is a combustion engine pump 102 located at or near the well site. However, clearly, the downstream processed gas destination can be another location such as a holding tank 65, or a ground pipeline feeding processed gas into the energy grid infrastructure.

Trailer 12 may comprise additional components. By way of non-limiting example, a raised trailer platform 66 may be positioned above the top surface 24 and define a portion of platform 22. Ladders may be attached to trailer 12 to permit ingress and egress to platform 22. Landing gear 70 is provided adjacent the forward end 28 and positioned beneath raised platform 66 to support trailer 12 when it is in a stable and installed state (i.e., no longer being towed by truck 39).

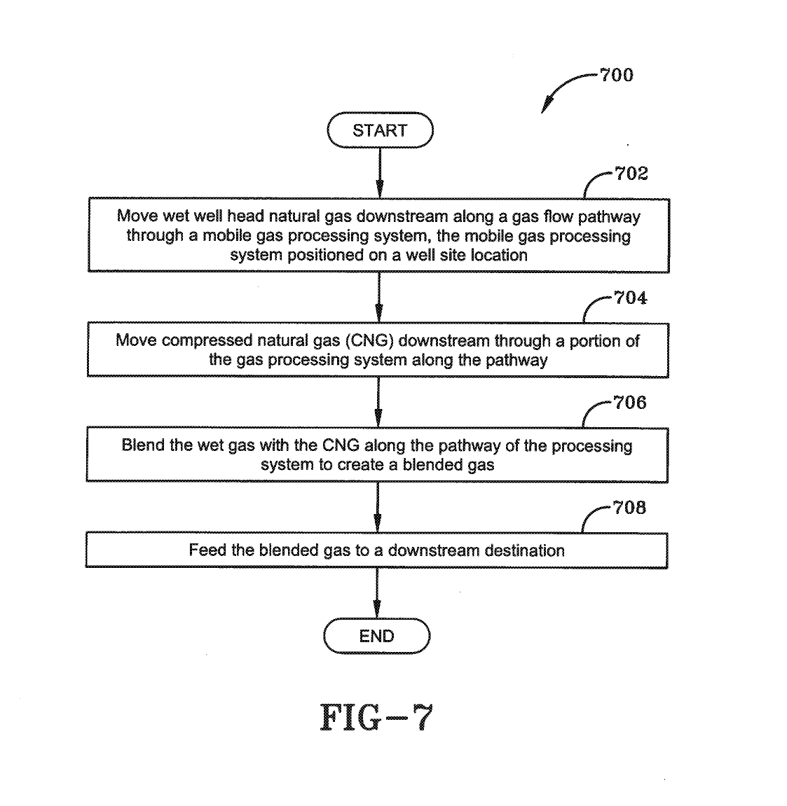

With primary reference to FIG. 7, a method for blending processed CNG with wet raw well head gas is shown generally at 700. Method 700 comprising the steps of: moving wet well head natural gas downstream along a gas flow pathway through a mobile gas processing system, the mobile gas processing system positioned on a well site location, shown generally at 702; moving compressed natural gas (CNG) downstream through a portion of the gas processing system along the pathway, shown generally at 704; blending the wet gas with the CNG along the pathway of the processing system creating a blended gas, shown generally at 706; and feeding the blended gas to a downstream destination, shown generally at 708. Clearly, it is to be understood that there may be additional intervening steps occurring therebetween any two steps should it be necessary in the art to accomplish the desired result of the method 700.

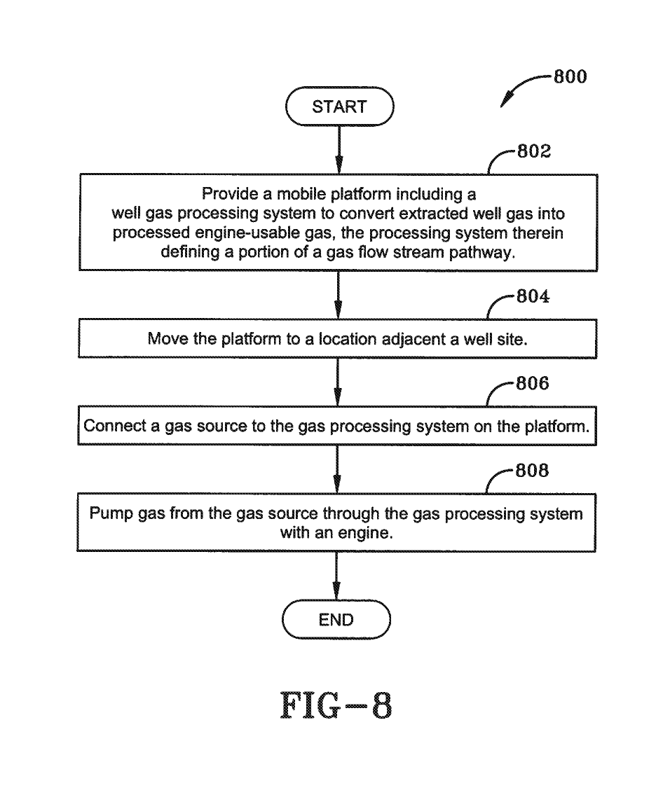

With primary reference to FIG. 8, a method of use for the present invention is generally shown as 800. Providing a mobile platform including a well gas processing system to convert extracted well gas into processed engine-usable gas, the processing system therein defining a portion of a gas flow stream pathway is shown at 802. Next, moving the platform to a location adjacent a well site is shown at 804. Then, connecting a gas source to the gas processing system on the trailer is shown at 806. And, then pumping gas from the gas source through the gas processing system with an engine is shown at 808. Clearly, it is to be understood that there may be additional intervening steps occurring therebetween any two steps should it be necessary in the art to accomplish the desired result of the method 800.

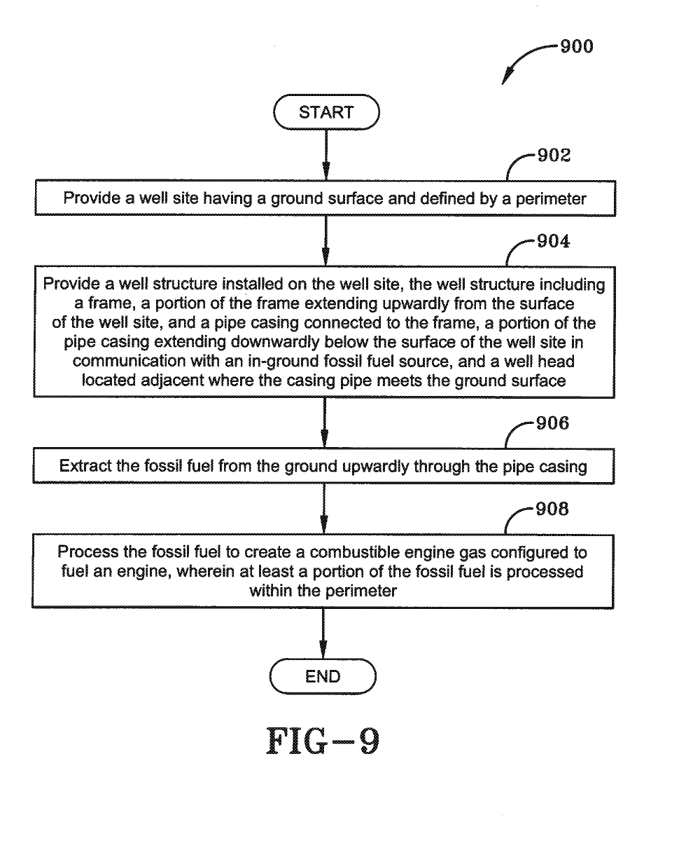

With primary reference to FIG. 9, a method of operating a well using gas processed at a same well site is generally shown as 900. Providing a well site having a ground surface and defined by a perimeter is shown at 902. Next, providing a well structure installed on the well site, the well structure including a frame, a portion of the frame extending upwardly from the surface of the well site, a pipe casing connected to the frame, a portion of the pipe casing extending downwardly below the surface of the well site in communication with an in-ground fossil fuel source, and a well head located adjacent where the casing pipe meets the ground surface is shown at 904. Then, extracting the fossil fuel from the ground upwardly through the pipe casing is shown at 906. And, processing the fossil-fuel to create a combustible engine gas, wherein at least a portion of the fossil-fuel is processed within the perimeter is shown at 908. Clearly, it is to be understood that there may be additional intervening steps occurring therebetween any two steps should it be necessary in the art to accomplish the desired result of the method 900.

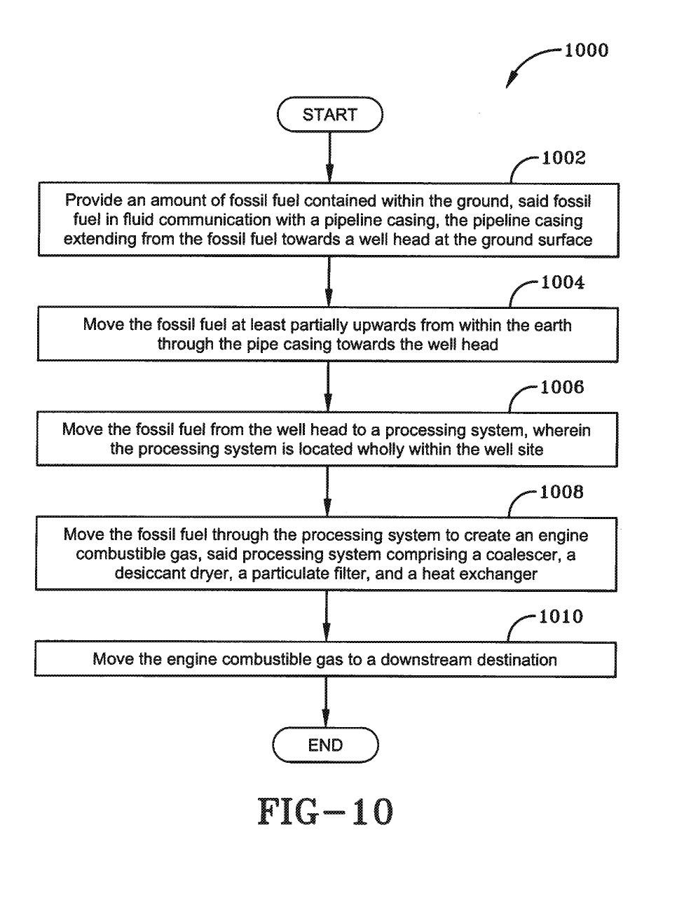

With primary reference to FIG. 10, a method of processing a fossil-fuel at a well site is shown at 1000. Providing an amount of fossil fuel contained within the ground, said fossil fuel in fluid communication with a pipeline casing, the pipeline casing extending from the fossil fuel towards a well head at the ground surface is shown at 1002. Next, moving the fossil fuel at least partially upwards from within the earth through the pipe casing towards the well head is shown at 1004. Then, moving the fossil fuel from the well head to a processing system, wherein the processing system is located wholly within the well site is shown at 1006. Next, moving the fossil fuel through the processing system to create an engine combustible gas, said processing system comprising a coalescer, a desiccant dryer, a particulate filter, and a heat exchanger is shown at 1008. And then, moving the engine combustible gas to a downstream destination is shown at 1010. Clearly, it is to be understood that there may be additional intervening steps occurring therebetween any two steps should it be necessary in the art to accomplish the desired result of the method 1000.

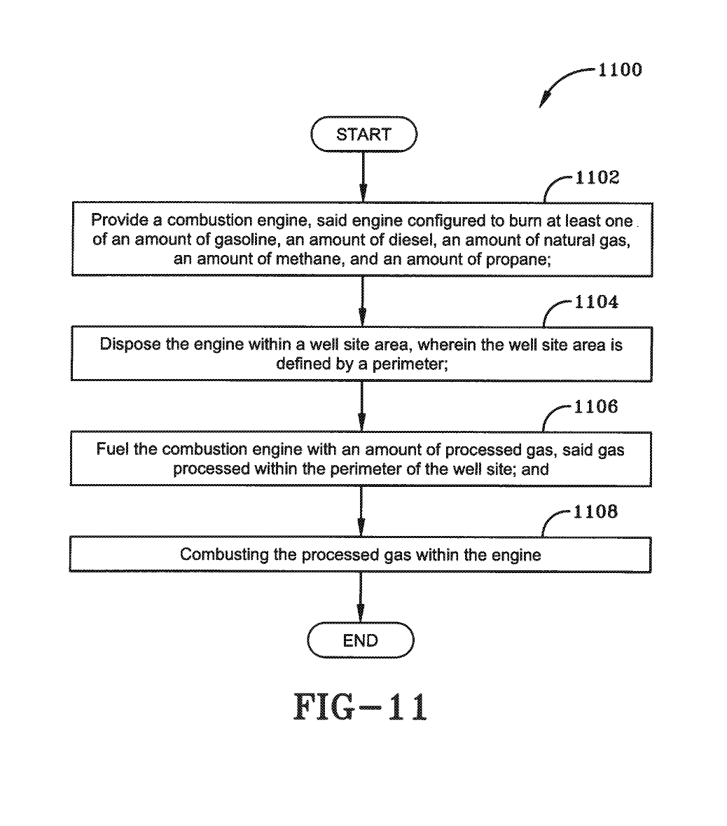

With primary reference to FIG. 11, a method of fueling an engine with an amount engine gas processed adjacent the engine's location is shown generally as 1100. Providing a combustion engine, said engine configure to combust at least one of an amount of gasoline, an amount of diesel, an amount of natural gas, an amount of methane, and an amount of propane is shown at 1102. Next, disposing the engine within a well site area, wherein the well site area is defined by a perimeter is shown at 1104. Then, fueling the combustion engine with an amount of processed gas, said gas processed within the perimeter of the well site is shown at 1106. And next, combusting the processed gas within the engine is shown at 1108. Clearly, it is to be understood that there may be additional intervening steps occurring therebetween any two steps should it be necessary in the art to accomplish the desired result of the method 1100.

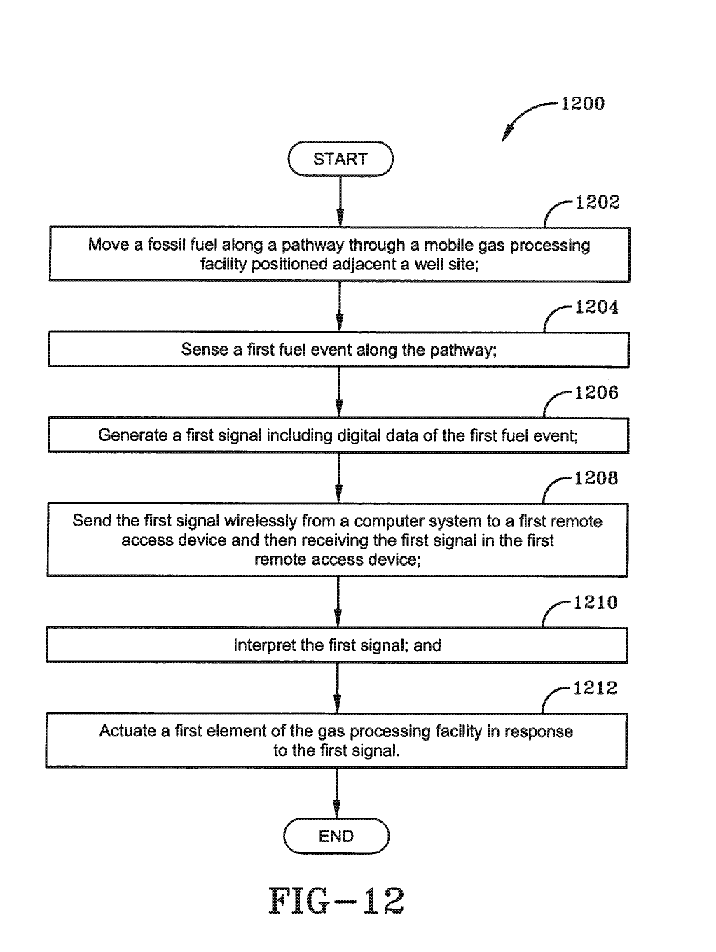

With primary reference to FIG. 12, a method for operating a gas processing facility is shown generally as 1200. The method 1200 comprises the steps of moving a fossil fuel along a pathway through a mobile gas processing facility positioned adjacent a well site, shown at 1202; sensing a first fuel event along the pathway, shown at 1204; generating a first signal including digital data of the first fuel event, shown at 1206; sending the first signal wirelessly from a computer system to a first remote access device and then receiving the first signal in the first remote access device, shown at 1208; interpreting the first signal, shown at 1210; and actuating a first element of the gas processing facility in response to the first signal, shown at 1212. Clearly, it is to be understood that there may be additional intervening steps occurring therebetween any two steps should it be necessary in the art to accomplish the desired result of the method 1200.

In accordance with an aspect of the present invention the mobile gas processing facility 10 provides a mobile gas processing system 20 for processing down-hole wellhead gas 110 upon extraction locally adjacent the well site; where gas 110 was extracted. System 10 is hauled via truck 39 to the well site and temporarily installed and connected to source lines. As gas processing system 20 processes the gas local to the well site, a clean processed gas 111 is output and runs or fuels an engine, such as well pumps 102, at the well site. When completed gas is no longer needed to be pumped at the well site, system 10 may be hauled away.

In accordance with another aspect of the present invention, the mobile gas processing facility 10 permits in situ processing of raw gas 110 to a clean useable gas 111. The clean gas 111 is used locally at the well site within the machines 102 that operate the well. For example, raw gas is pumped out of a down hole well, then it is processed and cleaned on site via the present invention 10, then the clean gas is used in the well pump 102 that extracted said same gas from the down-hole well.

In accordance with an additional aspect of the present invention, system 130 permits the wireless control and operation of processing system 20. Wireless control of system 130 allows an end user to remotely control the flow or movement of gas during processing using a mobile smartphone or other similar devices. The advantage of this is that an operator can shut-down or divert flow of gas during the processing process when they are not physical observing system 20. This allows the operator to be located at a safe distance remote from and outside perimeter 200 of the well site.

In accordance with yet another aspect of the present invention, system 20 permits an operator to blend an amount of previously processed CNG with an amount of wet and raw extracted fossil fuel. One advantage of the blend is that the blend is combustible in an engine outputting a similar amount of work as pure CNG. The blend of CNG and wet gas provides sufficient BTUs for operation within a natural gas engine, ordinarily a former diesel engine converted to run on natural gas. The converted engine receives the fuel blend and is able to combust the blend in a cylinder chamber without risk of damage beyond ordinary wear-and-tear to the converted engine components. Further, the blended fuel mixture is believed to be a cheaper alternative to fuel as less costs is needed to produce a burnable amount of blended fuel, rather than an equal volume of pure CNG.

In accordance with yet another aspect of the invention, the blending of CNG with wet well head gas within blending chamber 145 permits the blend to have a desired British Thermal Unit (BTU) rating for combustion within an engine. For example, typically CNG is approximately around 1000 BTUs, and well head gas from the Ohio region can be around 1500 BTUs. However, a diesel engine converted to run on natural gas desirably burns fuel at about 1200 BTUs. Thus, the blending of low BTU gas with higher BTU gas allows the blend or mixture to be combusted within a converted engine. Preferably, the natural gas blend consists essentially of: a first amount of raw wet well head natural gas; and a second amount of processed and compressed natural gas. The blend has a British Thermal Unit (BTU) in a range from about 1000 BTUs to about 1500 BTUs. More particularly, the gas blend has a BTU range from 1200 BTUs to 1300 BTUs.

In accordance with yet another aspect of the invention, the blending of CNG with wet well head gas 110 permits a well 106 drilled on at a well site location and a processing and collection system has not yet been laid/installed to provide gas from other locations, CNG could be used for the drilling and completion of the first well. Further, if there is natural gas available at the well site, but the available quantity is not sufficient to operate the required completion equipment, CNG can be added to make up the deficit. Even further, if the well head gas 110 has a very high Btu value, when cooled by low ambient temperature in winter months, the gas temperature could drop below the hydrocarbon dew point causing liquids to fall out of the gas. These liquids cannot be used in a natural gas engine and may damage that engine. The addition of CNG that has already been stripped of these heavy hydrocarbons can be added and the blended gas will have a lower Btu value and lower hydrocarbon dew point to prevent the fallout of these liquids. Also, blending well head gas 110 with CNG allows a heater to be used as a vaporizer to convert LNG (liquefied natural Gas, or propane) back to a gaseous state and regulate the pressure for use in engines.

In operation and with primary reference to FIG. 1, the mobile gas processing facility 10 of the present invention is towed or hauled to a gas well site via truck 39, the well site shown as encompassing the environmental view of FIG. 1. Once at the well site, an inlet line 100 (which defines a portion of gas flow stream pathway 14) is connected between a well pump 102 and an inlet 104 to gas processing system 20.

If a well 106 has more liquid production than the natural gas 110 can lift by its pressure, the mechanical pump/artificial lift device 102 is installed. The pump 102 pumps or lifts liquids to the surface through tubing housed within casing 108. The extraction tubing is ordinarily the smallest of the pipes inside the down-hole casing 108. Preferably, the extraction tubing is positioned and centered concentrically within the casing 108. No gas is processed in the down-hole tubing. The pump lifts the liquids only.

Well pump 102 is in communication with a gas well frame 106 having a down-hole pipe or pipe casing 108 in fluid communication with a pocket of gas or other fossil fuel 110 contained within the earth surface 112. Well pump 102 is engaged and begins pumping raw wellhead gas or the fossil fuel 110 out of the earth 112. The raw wellhead gas (fossil fuel) 110 flows upwardly towards the earth surface by the urging of well pump 102 at the well site. Upon reaching the surface at the well head 109, gas 110 is moved towards present invention 10, and more particularly processing system 20, via line 100.

When fluids are extracted along with the raw well head natural gas 110, a pipe caries both the fluid and the gas to a separator unit where the fluid and raw gas 110 are separated. The fluids are moved along another pipeline to storage tanks on the well site location. The well head gas 110 is moved towards system 20 via line 100.

Alternatively, when fossil fuel is sufficiently pressurized within the earth, the pressurized fossil fuel 110 can flow upwards via its own pressure without the need for a pump. Many wells 106 have sufficient gas flow to raise the liquids with the gas through the tubing or production casing. Ordinarily, this pressurized fluid and raw gas 110 mixture is at a high pressure exceeding the capabilities of processing system 20 mounted to the mobile platform 22. In this instance, a separator unit has a glycol bath heater and multiple coils with chokes that cause an initial pressure drop before going into the separator. This separator removes the most of the liquids and moves the remaining raw gas 110 towards processing system 20.

Gas 110 continues to flow along gas flow stream pathway 14 through pipeline 16 and is processed through system 20 (the process described in further detail below with references to FIGS. 2-6). Once raw gas 110 has been processed into a clean gas 111, it leaves system 20 via a system outlet 105. Clean gas 111 is then fed from outlet 105 to a downstream destination, preferably an internal combustion engine positioned on the well site. As shown in FIG. 1, clean gas 111 flows via out let line 101 to pump 102. Clean gas 111 fuels and runs pump 102 forming a locally contained cycle in which the well gas 110 is processed into clean useable gas 111 to fuel machines located at the well site. While the exemplary view shown in FIG. 1 depicts the clean gas 111 fueling pump 102, clearly clean gas 111 can be routed via additional piping to fuel other gas operated machines (not shown) locally at or near the well site, or connected to an existing energy grid infrastructure pipeline. The engine is located within the perimeter and is preferably in communication with at least one of a pump, and electric generator, and a heat exchanger.

Often to get the engine started, engine gas processed outside of parcel 202 must be brought in on a truck or piped in from off site. The offsite processed gas (stored in offsite source 181) is first combusted in the engine to operate the pump 102. Then, combustion of the second engine gas in the engine is ceased when the processing system has created the first engine gas within the perimeter (processing of gas described below with reference to FIGS. 2-6). The engine quality gas processed within the perimeter 200 is then combusted within the engine to drive pump 102. Alternatively, the gas processed outside parcel 202 may be stored as CNG source 180, now mounted within perimeter 200. Source line 185 may be connected to engine 102 to start the combustion cycle, then when system 20 begins outputting clean gas, a valve 80 may be turned off so engine 102 may run on fuel processed from system 20.

In operation and with primary reference to the gas processing system 20 shown in FIGS. 2-6, wellhead gas 110 enters processing system 20 at inlet 104, said inlet 104 defining a portion of pathway 14 therethrough. The shown embodiment provides two inlets 104 located on each of the left 32 and the right 34 sides of trailer 12. Pipelines 16 extend from inlet 104 to converge prior to an emergency shut-down valve 120. Gas flows through shut-down valve 120 and may be split to flow in one of two directions. A first pathway segment 122 defined by pipeline 16 directs gas towards coalescer 40. A second pathway 124 segment defined by pipeline 16 is considered a bypass segment, which allows gas to flow directly to heat exchanger 46 bypassing coalesce 40, dryer 42, and particulate filter 44. By way of non-limiting example, a user would direct gas through second segment 124 to bypass components that may be under repair.

Gas flows from first segment 122 to coalescer 40. Coalescer 40 defines a portion of pathway 14 therethrough. In operation, and with primary reference to coalescing filter 40, gas flows into filter 40 from pipeline 16 through coalescer inlet 40A. Coalescer 40 is configured to perform coalescence of gas 110. Coalescing filter 40 removes free fluids from the gas, the free fluids being precipitated liquids. Thus, the coalescence of gas 110 allows filter 40 to separate the emulsion of gas 110 into separate components. It is contemplated that coalescer 40 is a mechanical-type coalescer ordinarily associated with the oil and gas industries. Mechanical coalescers 40 preferably remove water or hydrocarbon condensate contained in well gas 110. Electric coalescers are contemplated as well in lieu of the mechanical coalescer 40 herein described.

By way of non-limiting example, coalescer 40 with reference to the oil and gas, petrochemical and oil refining industries, often utilizes a liquid-gas coalescer type to remove water and hydrocarbon liquids to <0.011 ppmw (plus particulate matter to <0.3 um in size) from natural gas to ensure natural gas quality and protect downstream equipment such as compressors, gas turbines, engines, amine or glycol absorbers, molecular sieves, metering stations, gas fired heaters or furnaces, heat exchangers or gas-gas purification membranes.

Additionally, in the natural gas industry, gas/liquid coalescers 40 can be used for recovery of lube oil downstream of well pump 102 or a compressor. Liquids are removed but lube oil recovery can be recovered. Liquids from upstream of the compressor, which may include aerosol particles, entrained liquids or large volumes of liquids called “slugs” and which may be water and/or a combination of hydrocarbon liquids should be removed by a filter/coalescing vessel located upstream of the compressor. Efficiencies of gas/liquid coalescers are typically 0.3 Micron liquid particles, with efficiencies to 99.98%. Liquid-liquid coalescers 40 can also be used to separate hydrocarbons from water phases such as oil removal from produced water. A liquid-liquid coalescer may be useful in the removal of pyrolysis gasoline (benzene) from quench water in ethylene processing facilities.

Once the gas exits through outlet 40B from coalescer 40, gas travels via pipeline 16 along pathway 14 towards manifold 50. Manifold 50 has preferably one inlet and at least two outlets. A first manifold outlet is in communication with the first dryer 42, and a second manifold outlet is in communication with the second dryer 43. One exemplary purpose of the valve manifold 50 is to allow the field service operator the ability to choose which desiccant dryer the gas will go through. Manifold 50 may further be selectively operable by user, in that one or more of the at least two outlets may be closed to purposefully direct gas flow towards either of the first or second dryers 42, 43. An exemplary advantage of the selectively operable manifold 50 is allowing the user to run or operate one dryer and service the other dryer while the whole system 20 continues to operate. Gas flows through manifold 50 and down either of pathway segments 14A, 14B. Segment 14A leads gas to first dryer 42, and second segment 14B leads gas to second dryer 43.

With reference to the first desiccant dryer 42, gas flows from manifold 50 to dryer inlet 42A. Inlet 42A is preferably located adjacent the bottom and formed in the cylindrical sidewall of desiccant dryer 42. Dryer 42 contains a plurality of gas-drying desiccant therein. Desiccants (not shown) are small pellets which act to absorb moisture from the gas flowing over, around, and near the pelletized desiccants. An exemplary set of desiccants are commercially available for sale under the name GasDry™ and are manufactured and distributed by Van Gas Technologies of Lake City, Pa. However, clearly other commercially available desiccants may be substituted. Desiccants within dryer 42 remove water vapor from natural gas during production, transmission, and distribution. Gas dries out and flows through interior chamber of dryer 42 towards outlet 42B. Outlet 42B is preferably adjacent the top and formed in the cylindrical sidewall of dryer 42.

With reference to the second desiccant dryer 43, gas flows from manifold 50 to dryer inlet 43A. Inlet 43A is preferably located adjacent the bottom and formed in the cylindrical sidewall of desiccant dryer 43. Dryer 43 contains a plurality of gas-drying desiccant therein. Desiccants may be the same as the desiccants contained in dryer 42, or alternatively, they may have different absorbent properties to impart a desired outcome on the gas. Gas dries out and flows through interior chamber of dryer 43 towards outlet 43B. Outlet 43B is preferably adjacent the top and formed in the cylindrical sidewall of dryer 43.

From dryer 42, 43 pipelines extend downstream and converge, allowing dried gas to flow towards particulate filter 44. Gas enters particulate filter 44 through inlet 44A adjacent the bottom and formed in the cylindrical sidewall of filter 44. The particulate filter 44 is a carryover gas filter. Particulate filter 44 is configured to remove particulates still remaining within dried gas flow stream. Ordinarily, as one would understand in the art, two types of particulate filters can operate to perform the particulate filtering task of filter 44. A fabric filter, having a sock liner therein, can be used to capture particulate matter, or a carbon filter to capture organic impurities can be used. One exemplary sock filter 44 is commercially manufactured and distributed by Filtration Systems, Inc. of Waukesha, Wis.

From filter 44, filtered gas flows along pathway towards heat exchanger 46. Upon approaching heat exchanger inlet 46A, the gas pressure can be as high as 1250 pounds per square inch (PSI). Often the wellhead gas 110 pressure is this amount and it remains relatively constant through pipeline 16 up to the inlet 46A of heat exchanger 46. However, gas at such a high pressure cannot ordinarily be used in a combustion engine. Thus, the gas pressure must be reduced so it can be fed into a combustion engine. Typically, combustion engines operate with a gas line pressure of about 85 PSI. Thus, the pressure may need to be reduced by about 1200 PSI. However, expanding gas to reduce pressure causes an extraordinary amount of heat loss. During gas expansion to reduce pressure, for about every 100 PSI reduced, the temperature of the gas through thermal expansion decreases by about 7° C. Heat exchanger 46 keeps the flowing gas from freezing, liquefying or condensing while the gas is expanding by applying heat to the gas. This heat application allows the gas to expand and reduce in pressure, while maintaining an amount of heat to prevent liquid gas from forming.

With continued reference to heat exchanger 46, pipes 56 are maintained at a sufficiently high temperature by the heated fluid mixture (glycol, ethylene, and water) to prevent the liquefying of gas as it expands. The fluid mixture submerges the pipes in a bath at a temperature in a range from 150° F. to 200° F. The heating element is maintained around 750° F. which is in communication with the fluid and in turn heats the fluid mixture. Heater 46 is an indirect heater and is usually filled with a mixture of ethylene glycol (antifreeze) and water. However other heavier glycols (diethylene and triethylene) can be used with or without water to increase differential temperature and heater efficiency. The gas is heated to sufficient temperature to counteract the expansion cooling when regulators 52 cause the final pressure drop.

One embodiment of the heat exchanger 46 has two inlets 46A, 146A which are in communication with the blending chamber 145. Raw unprocessed wet gas may bypass portions of system 20 and connect to inlet 46A. Previously processed and compressed natural gas may connect to inlet 146A. The raw wet well head natural gas is moved along a pathway from the well 106 to inlet 46A. The processed CNG is moved along another pathway from source 180, or 181 along line 185 towards 146A. The two streams of raw wet well head natural gas and CNG are blended in blending chamber 145. Preferably, blending occurs in chamber 145 via pedesis or dispersion, as raw wet well head natural gas contains fluids and other particulate matter suspended therein.

Once gas has decreased to a pressure of about 85 PSI, gas exits outlet 46B and travels via pipes 16 along pathway 14 towards regulators 52. A pipe branches into two segments upstream of regulators 52 permitting gas to flow towards a first set of regulators 53 or a second set of regulators 55. By way of example, and drawing a reference to an electrical circuit, first and second set of regulators 53, 55 are fluidly aligned in parallel, just as two resistors in a circuit can be connected in parallel. Note that the physical location of first and second sets 53, 53 need not be actually parallel. The term parallel is with reference to the flow stream of gas when compared an electrical circuit.

When flowing through the first set of regulators 53, gas travels first through an active regulator 53A then through a monitoring regulator 55B. Active or working regulator 53A regulates the amount of gas traveling downstream, while 55B monitors the amount of gas passing therethrough. Second set of regulators 55 have an active or working regulator 55A and a monitoring regulator 55B similarly functioning and aligned in a similar manner. Downstream from the two segments defined by first and second regulators 53 and 55, pathway 14 converges in a t-fitting pipe 16 so the two regulated streams become one. These pairs of regulators are nominally called a worker 53A, 55A, and a monitor 53B, 55B. The worker regulator 53A or 55A is the one that does the pressure regulating in normal use. The monitor 53B or 55B is the backup, in case the worker 53A, 55A has a mechanical failure and pressure rises above the wanted set pressure. The monitor 53B, 55B is usually set one to two pounds higher than that of the respective worker 53A, 55A.

Regulators 52 in parallel may include more than two sets, as the gas requirements may dictate. Regulators 52 have a range of flow based on the orifice size and amount of pressure drop, across that orifice. The orifice is located within each respective regulator 53A, 53B, 55A, 55B. If the flow rate is too low, the regulator will not have a steady flow as it cannot react to the pressure changes it monitors fast enough and will start going open then closed and never settle down to a constant throttling action. This will damage the regulator. If the required flow is higher than the regulator is capable of passing (above critical flow) the outlet pressure will drop below the set point (required pressure). The regulators 52 are staged with each set of regulators having a larger orifice size than the preceding set, i.e. able to flow larger quantities of gas. A “set” of regulators refers to the working regulator and the monitoring regulator aligned in series; for example first set 53A, 53B. The first set 53A, 53B is set to open at the higher pressure and will begin to open causing the flow of a small amount of gas. This is usually sized to handle the natural gas fueled engines at idle. As more engines are added, or throttled up a larger amount of gas is required. When critical (maximum) flow is reached, the pressure in the discharge line will begin to drop. When this happens, the second set 55A, 55B of regulators begins to open to try and maintain the amount of gas flow needed. This second set of regulators 55A, 55B has been set about one or two pounds lower than the first, so they will remain closed until the additional gas flow is required. If the need for gas is large enough, a third and fourth set of regulators (not shown) can be staged similarly to provide this required gas flow.

Downstream from regulators 53A,53B55A,55B, gas flows through orifice meter 49 within meter run 48. Meter 49 ensures the proper amount of now processed gas is fed to outlet 105. As described above, gas leaves outlet 105 and is fed to an engine located at the well site.

Now clearly, the objective of every gas extracting well operation is not to break even and just run the machines at a given site. The present invention 10 has a plurality of ports in communication with processed gas that connect to storage tanks or that feed into a pipeline infrastructure grid so that excess processed gas can be sold for a profit.

Additional elements are contemplated as existing in system 10. For example, various inlets may be positioned along pathway 14 to allow for additives to be fed into stream pathway. One such additive may be compressed natural gas. Sometimes, coalescer 40, dryers 42, 43, and filter 44 may be bypassed and a source of wellhead gas may be mixed with already processed compressed natural gas in the heat exchanger 46. This allows well head gas to achieve a desirable amount of BTUs while the mixture is still clean enough to meet the engine useable gas criterion specifications.

In operation and with reference to computer system 130, a method of operating the processing system 20 of facility 10 can be wirelessly conducted through program logic. As fossil fuel 110 is moved along the pathway 14 through the mobile gas processing system 20 positioned adjacent a well site, the fossil fuel is sensed by sensors in communication with an electric signal generator 131. The sensors are mounted and positioned along the pathway 14. Specifically, the sensors sense a first fuel event. An exemplary first fuel event includes but is not limited to: a change in fossil fuel pressure, a change in fossil fuel temperature, a change in fossil fuel volume, and a change in fossil fuel flow rate, as the fossil fuel or gas moves along pathway 14. The purpose of sensing the physical properties of the gas throughout the system is to ensure safe processing. For example, if gas pressure increases too quickly, a response is needed from the system 130 to send a warning signal containing information about the fuel event (warning that the pressure is too high), so that a valve 80, 120 may be shut down remotely from an access device, such as an iPad®. This allows a human operator to be located off-site at a safe distance away from and outside perimeter 200 of the well site, while maintain constant surveillance of the physical properties as system 20 process the fossil fuel at facility 10.

After the first fuel event is sensed by the sensor, a first signal is generated by signal generator 131 in communication with system 130. The first signal is sent wirelessly from computer system 130 to the first remote access device and wherein the first signal is received in the first remote access device. The way in which the signal may be sent wirelessly from the computer system to the first remote device is accomplished by any one of a wireless fidelity (Wi-Fi) internet connection, a mobile broadband internet connection, a baseband signal, a passband signal, and a Radio Frequency (RF) signal, amongst others.

The remote access device interprets the first signal. The remote access device then displays the signal in a graphical user interface understandable to the human operator. The operator then moves or actuates a touch screen display or button on the remote access device in response to the first signal, thereby generating a second response signal from within the remote access device. The remote access device then communicates with system 130 of processing facility 20, through the second signal, to move or actuate actuating a first element of the gas processing facility in response to the first signal. Preferably, the first element of facility 20 is emergency shut-down valve 120 or conventional gas valve 80 which moves between open and closed positions to stop the flow of gas through system 20. Alternatively, the first element is a pump 102 which moves gas along the pathway 14.

Valves 80, 120 may be positioned between the system inlet and upstream from a coalescer; the valve 80, 120 may be positioned downstream from a coalescer and upstream from a dryer; the valve 80, 120 may be positioned downstream from a dryer and upstream from a filter; the valve 80, 120 may be positioned downstream from a filter and upstream from a heat exchanger; or the valve 80, 120 may be positioned downstream from a heat exchanger and upstream from a system outlet, amongst other places.

When the remote access device is interpreting the digital information regarding the first fuel event, the remote access device reads at least one fuel event parameter range contained on a digital medium. The range relates to a safe operation of the fuel moving along pathway 14. So by way of non-limiting example, a fuel parameter range may state that the safe operating pressure of the fossil fuel in pipelines 16 is a range from 50 PSI to about 2000 PSI. The information from the fuel event is compared to the range and it is determined if the first signal of information is within the range. If the pressure is higher than 2000 PSI within pipeline 16 and is thus outside the safe operating range, the remote access device prompts the actuation of the first element (i.e., the emergency shutdown valve) when the first signal is outside of the fuel parameter event range. The parameter range may also be known as a contiguous data array.

After sensing the first fuel event, system 130 senses a second fuel event along the pathway. Signal generator 131 generates a second signal including digital data of the second fuel event. System 130 sends the second signal wirelessly from the computer system 130 to the first remote access device and then the remote access device receives the second signal. The second signal is then interpreted and compared to the array of safe operating ranges, for example a safe temperature range, a safe pressure range, or a safe flow rate, amongst other possible operating parameters. Either system 130 or the remote access device can generate a stop interrupt signal if the second fuel event is within the array of safe operating ranges. Preferably, system 130 then actuates the first element (i.e. valve 80 or 120) to a position in response the second signal. The valve position is different than that of the actuated element in response to the first signal. So for example, the first signal could open valve 80, and the second signal could close valve 120.

Additional embodiments permit the second signal to contain a stop interrupt signal to be sent immediately in the event first fuel event is outside the safe parameter range. For example, if the first signal is within a safe operating range, then a second signal is outside the safe range, the second stop interrupt signal can be sent from the remote access device wirelessly to wholly shutdown system 20 or even facility 10.

Another alternative embodiment of the method of operating a gas processing facility can provide a fossil fuel processing system located adjacent a gas well site. Then, the system 130 collects digital data of the fossil fuel's physical properties while the fossil fuel moves from upstream to downstream through the processing system 20. A computer system 130 then can compare the physical properties data with a contiguous array contained in a computer processing system 130. The computer should then interrupt the fossil fuel movement when the physical properties data is outside the contiguous array of safe operating ranges. And then, a signal generator 131 transmits a signal wirelessly to a remote access device. An end user reviews the signal on a graphical user interface formed in the remote access device.

The term “wet well head natural gas” refers to an extracted fossil fuel containing fluids and particulate matter in a raw and unprocessed state after being extracted from the ground.

Additional exemplary embodiments contemplated by the present invention are disclosed in United States patent application entitled “A METHOD FOR OPERATING A GAS PROCESSING SYSTEM” and in United States patent application entitled “A METHOD FOR OPERATING A WELL SITE”, both filed contemporaneously on equal date herewith in the name of the same inventors and assigned to the same entity, the entirety of each is herein incorporated by reference as if fully rewritten.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A method comprising the steps of:
moving wet well head natural gas downstream along a gas flow pathway through a mobile gas processing system, the mobile gas processing system positioned on a well site location;
moving processed and compressed natural gas (CNG) downstream through a portion of the gas processing system along the pathway;
blending the wet gas with the CNG along the pathway of the processing system creating a blended gas; and
feeding the blended gas to a downstream destination.

2. The method of claim 1, the step of blending further comprising the steps of:
directing the wet gas into a blending chamber defined by a heat exchanger;
directing the CNG into the blending chamber; and
dispersing each of the wet gas and the CNG in the blending chamber.

3. The method of claim 2, wherein the step of dispersing further comprises:
moving gas particles in the blending chamber by pedesis.

4. The method of claim 1, further comprising the steps of:
positioning the downstream destination on the well site location.

5. The method of claim 4, further comprising the steps of:
combusting the blended gas within an internal combustion engine at the downstream destination.

6. The method of claim 1, the step of blending further comprising the steps of:
attaching a CNG source line to a first inlet formed in a heat exchanger;
directing the CNG through the source line into a blending chamber defined by the heat exchanger
attaching a wet gas pipeline to a second inlet formed in the heat exchanger; and
directing the wet gas through the pipeline into the blending chamber.

7. The method of claim 1, the step of moving CNG downstream through a portion of processing system further comprising the steps of:
connecting a CNG source to an inlet of the processing system;
moving CNG from the source along a pipeline towards the inlet; and
sending CNG into the system through the inlet.

8. The method of claim 7, further comprising the steps of:
positioning the CNG source outside a perimeter defining the well site location.

9. The method of claim 7, further comprising the steps of:
positioning the CNG source inside a perimeter defining the well site location.

10. The method of claim 1, the step of blending further comprising the steps of:
decreasing the blended gas pressure from a first pressure to a second pressure, the first pressure higher than the second pressure;
heating the blended gas as the pressure is decreased.

11. The method of claim 10, the step of heating the blended gas, further comprising the steps of:
submerging a blending chamber in a fluid mixture; and
heating the fluid mixture to a temperature in a range from 150° F. to 200° F.

12. A mobile gas processing system positioned on a well site location, the gas processing system comprising:
a heat exchanger including at least two inlets and adapted to receive compressed natural gas (CNG) through a first inlet and wet gas through a second inlet; and
a blending pathway defined by the heat exchanger;
wherein the two inlets are in fluid communication with the blending pathway.

13. The mobile gas processing system of claim 12, further comprising:
a fluid filled chamber, the fluid filled chamber defined by the heat exchanger; and
a pipeline in communication with the blending pathway, said pipeline winding within the fluid filled chamber.

14. The mobile gas processing system of 13, wherein the fluid comprises:
glycol;
ethylene; and
water.

15. The mobile gas processing system of 13, further comprising:
a heating element in communication within the fluid filled chamber at a first temperature; and
a second temperature of the fluid, wherein the first temperature is greater than the second temperature, and the second temperature is in a range from 150° F. to 200° F.

16. The mobile gas processing system of 15, wherein the second temperature in is in a range from 170° F. to 180° F.

17. The mobile gas processing system of 16, wherein the second temperature is 175° F.

18. The mobile gas processing system of claim 15, wherein the first temperature is in a range from about 600° F. to about 800° F.

19. The mobile gas processing system of claim 12, in combination with a CNG source located outside of a perimeter defining the well site location, the combination comprising:
a pipeline extending over the perimeter connecting the CNG source to one of the at least two inlets.

20. The mobile gas processing system of claim 12, further comprising:
a CNG source located inside a perimeter defining the well site location; and
a pipeline connecting the CNG source to one of the at least two inlets.

21. A natural gas blend consisting essentially of:
a first amount of raw wet well head natural gas; and
a second amount of processed and compressed natural gas;
wherein the blend has a British Thermal Unit (BTU) in a range from about 1000 BTUs to about 1500 BTUs.

22. The gas blend of claim 21, wherein BTU range is from 1200 BTUs to 1300 BTUs.
